(19) United States
(12) Patent Application Publication
(10) Pub. No.: US 2013/0188813 A1
(43) Pub. Date: Jul. 25, 2013

(54) HEARING ASSISTANCE SYSTEM AND METHOD

(71) Applicant: Bernd Waldmann, Maur (CH)

(72) Inventor: Bernd Waldmann, Maur (CH)

(73) Assignee: ADVANCED BIONICS AG, Zug (CH)

(21) Appl. No.: 13/813,843

(22) PCT Filed: Aug. 2, 2010
(86) PCT No.: PCT/EP2010/061225

§ 371 Date: Mar. 4, 2013

(51) Int. Cl. H04R 25/00

(52) U.S. Cl. CPC H04R 25/50
USPC 381/315; 381/321

(57) ABSTRACT

An at least partially implantable hearing assistance system, having an audio signal source, an audio signal processing unit for processing audio signals from the audio signal source, an implantable output transducer for stimulating a user's hearing according to the processed audio signals, a hermetically sealed gas-filled chamber forming part of said output transducer or forming part of an microphone as said audio signal source, a barometric pressure sensor for sensing the presently prevailing atmospheric pressure, and a correction signal unit for generating a correction signal as a predetermined function of the sensed atmospheric pressure, wherein said correction signal is adapted to be used by a pressure compensation element of the system for adjusting the system gain in a manner so as to compensate for the impact of deviations of the atmospheric pressure from a reference value on the compliance of said gas-filled chamber.

### BACKGROUND OF THE INVENTION

1. Field of the Invention

The present invention relates to an at least partially implantable hearing assistance system comprising an audio signal source (typically an implanted microphone or an external microphone), an audio signal processing unit for processing audio signals from the audio signal source and an implantable output transducer for stimulating the user's hearing according to the processed audio signals.

2. Description of Related Art

Implantable hearing devices, such as implantable middle ear hearing devices (IMEHDs) or fully implantable cochlear implants (CI), include implantable output transducers (actuators) and, at least if fully implantable, also implantable input transducers (microphones). Such input or output transducers typically contain gas-filled chambers, such as gas-filled microphone chambers connected to a pressure sensor for capturing audio signals from ambient sound, or gas-filled chambers housing in armature receiver or other electromagnetic element which converts electrical signals into mechanical motion (electromechanical transducers).

Since such chambers usually must be air-filled and since the materials used for such sensors of input transducers or motors of output transducers are not biocompatible, the air-filled chambers must be hermetically sealed in order to prevent contact with tissue and body fluids. Typically, such hermetic seal is realized as a membrane made of biocompatible material, which is laser-welded to the implantable housing. The gas pressure inside the air-filled chamber necessarily is equal to the barometric pressure, which prevailed at the time of manufacturing, and this pressure will remain for the entire lifetime of the device (assuming constant temperature, since a change in temperature necessarily will result in a corresponding change in pressure).

Changes in atmospheric pressure thus will inherently result in a pressure difference between the interior of the gas-filled chamber and the exterior volume surrounding the chamber, which, in turn, will cause a deflection of the membrane and hence a change in compliance of the membrane and of the assembly composed of the membrane and the attached component (such as a pressure sensor or an electromagnetic motor).

Similarly, changes in the temperature of the implanted device relative to the temperature prevailing during manufacturing will cause the gas in the gas-filled chamber to contract or expand, thereby also causing a pressure gradient across the membrane, resulting in a deflection of the membrane and a change of compliance.

Such changes in compliance of the membrane of the gas-filled chamber (and the resulting changes in compliance of the mechanical assembly of the hearing instrument, which includes such membrane) are generally undesirable, because they affect the sensitivity of the transducer and thereby the overall gain of the system.

In order to avoid such problems, manufacturers of such implanted devices place restrictions on the range of altitudes (i.e., barometric pressures) at which the user of such an implanted device may operate the device. However, such limitations are undesirable for the user, since it may limit the range of activities of the user, and it even may preclude certain activities completely, both for inadmissibly low pressures (which may occur, for example, in mountaineering) and inadmissibly high pressures (which may occur, for example, in diving). Moreover, even within the allowed range of barometric pressure, changes in altitude may result in audible changes in loudness of the hearing instrument.

An obvious and known approach to solve this problem is to make the membrane very compliant, for example, in the form of a bellows, in order to minimize the impact of compliance changes caused by air pressure changes; however, design and manufacture of a biocompatible, long-term stable bellows is difficult.

U.S. Patent Application Publication 2009/0112051 A1 relates to a fully implanted hearing aid comprising an implanted microphone and an implanted output transducer, wherein an implanted motion sensor is provided to observe changes in the operating conditions or the environment of the hearing aid for compensating the effects of such changes on hearing aid performance by appropriate filtering of the output signal of the implanted microphone. It is mentioned that the changes in operating environment may be due to changes in ambient environment conditions, such as barometric pressure, and that the model implemented in the compensation filter may include the gain of the system.

U.S. Pat. No. 8,063,891 B2 relates to a touch pad, such as for a portable computer, which includes an atmospheric pressure sensor in order to adjust the system gain according to the sensed atmospheric pressure for compensating for changes in coupling capacitance between the human body and the touch pad.

U.S. Pat. No. 2,680,779 relates to an airplane sound system, wherein the gain of the audio amplifiers is adjusted according to the altitude of the airplane in order to compensate for the density dependence of air on barometric pressure, so that the loudness of the perceived sound can be kept constant irrespective of the altitude of the airplane.

U.S. Pat. No. 7,204,800 B2 relates to an implantable hearing aid comprising an output transducer having a mechanical interface to the ossicular chain, which interface is adapted to compensate for the impact of changes in barometric pressure on the position of the ossicular chain.

U.S. Pat. No. 7,413,547 B1 relates to an implanted sensor for sensing body pressures, such as blood pressure.

### SUMMARY OF THE INVENTION

It is an object of the invention to provide for an at least partially implantable hearing assistance system, the performance of which should remain constant as far as possible even when the system encounters changes in atmospheric pressure. It is also an object to provide for a corresponding hearing assistance system.

According to the invention, these objects are achieved by an at least partially implantable hearing assistance system and a hearing assistance method as described herein.

The invention is beneficial in that, by providing the system with a barometric pressure sensor, means for generating a correction signal as a predetermined function of the sensed atmospheric pressure and a pressure compensation element using the correction signal for adjusting the system gain, the impact of changes in atmospheric pressure on the compliance of the gas-filled chamber, and hence the system performance, can be compensated for, so that system performance can be kept essentially constant irrespective of the presently prevailing atmospheric pressure. In particular, the function of the sensed atmospheric pressure may be a function of the difference between the sensed atmospheric pressure and a predetermined pressure value.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic view of an example of an implanted hearing assistance system according to the invention;

FIG. 2 is a schematic block diagram of an the system of FIG. 1;

FIG. 3 is a perspective view of the interior components of an example of an output transducer to be used with the present invention;

FIGS. 4 to 7 are schematic block diagrams like FIG. 2, wherein alternative examples of a system according to the invention are shown; and

FIG. 8 is a schematic view of an example of a hermetically sealed microphone to be used with the invention.

### DETAILED DESCRIPTION OF THE INVENTION

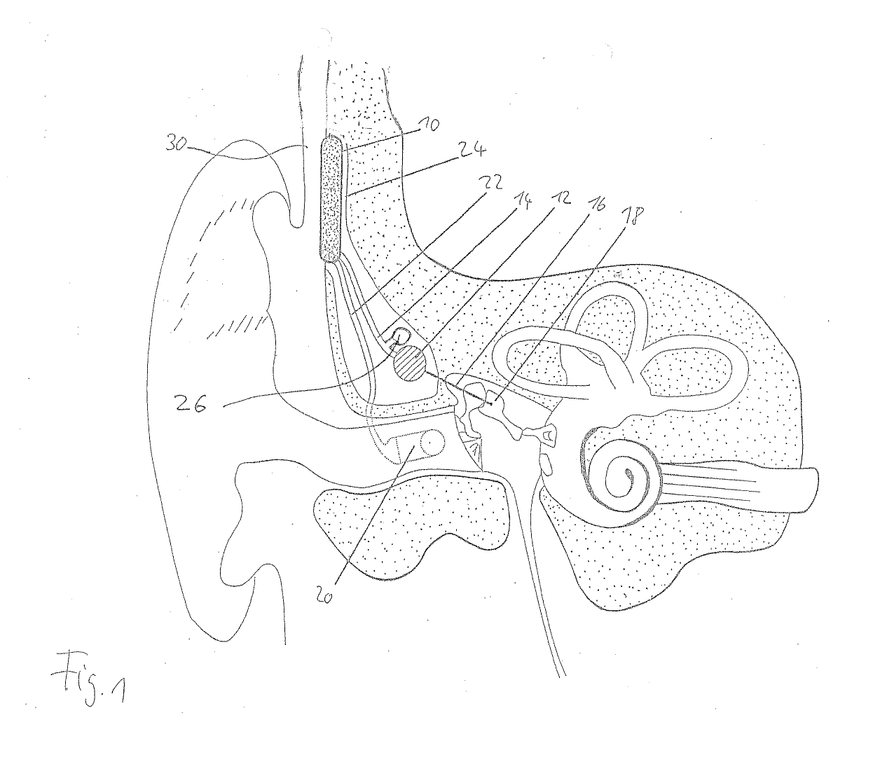

In FIG. 1, the example shown is a fully implantable hearing aid that comprises an implantable unit 10 having a hermetically sealed housing, and including an audio signal processing unit 40, an electric power supply 34, and optionally, components for wireless communication with a remote device. The hearing aid further comprises an implantable output transducer (actuator) 12, which is connected via implanted line 14 to the unit 10 and which, in the example of FIG. 1, is designed as an electromechanical transducer for vibrating, via a mechanical coupling rod 16, an ossicle 18, and an implanted microphone 20 connected via a line 22 to the unit 10. The unit 10 is accommodated under the skin 30 in an artificial cavity 24 created in the mastoid area.

The hearing aid also may comprise an implanted barometric pressure sensor 26, which is typically located close to the output transducer 12 or which may form part of the output transducer 12 and which is connected to the unit 10 via a line (in the example shown in FIG. 1 the pressure sensor 26 also uses the line 22).

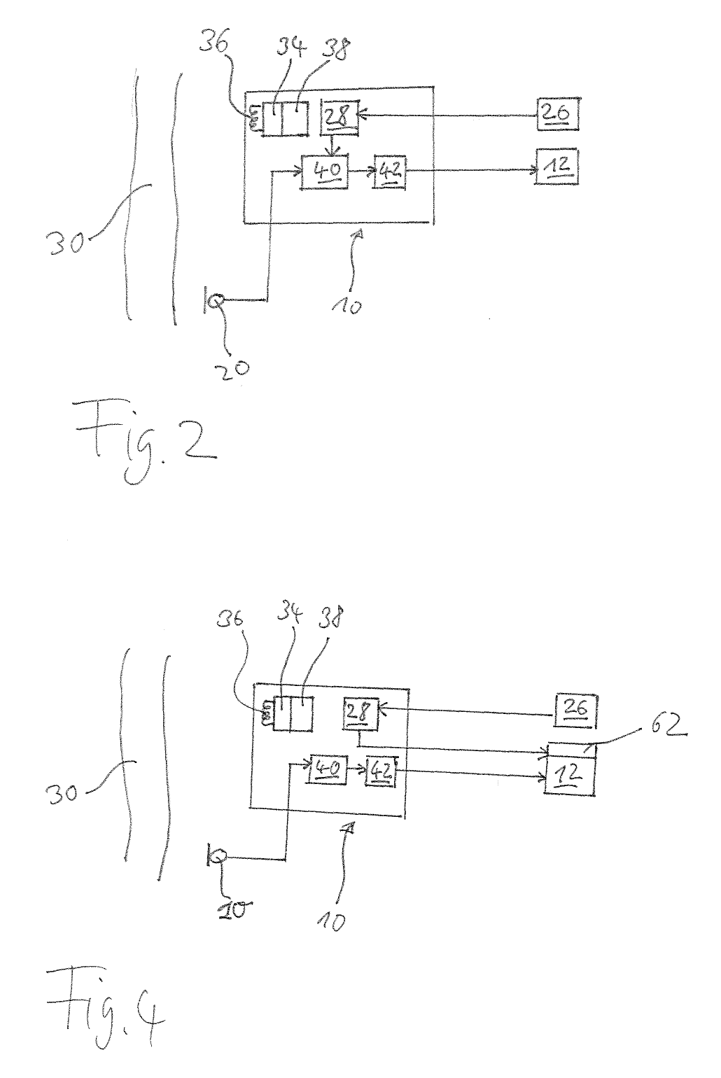

According to the block diagram of FIG. 2, the housing 10 contains a power supply 34 including an induction coil 36 for receiving electromagnetic power from a respective power transmission coil of an external charging device (not shown in FIG. 2) and a rechargeable battery 38. Typically, charging of the power supply 34 is carried-out during night when the user is sleeping. The audio signal processing unit 40 is typically realized by a digital signal processor (DSP), and it receives the audio signals captured by the microphone 20 and transforms them into processed audio signals by applying various filter techniques known in the art, which processed audio signals are supplied to a driver unit 42 for transforming them into a respective vibrational output of the transducer 12.

Rather than being implemented as an electromechanical output transducer actuating on an ossicle, the output transducer 12 also could be of any other known type of transducer including a hermetically sealed gas-filled chamber, such as an electromechanical transducer acting directly on the cochlear wall.

The implantable unit 10 also includes a correction signal unit 28, which is supplied with the output signal of the barometric pressure sensor 26 and which serves to generate a correction signal as a predetermined function of the pressure as sensed by the sensor 26. Such function of the sensed atmospheric pressure may be a function of the difference between the sensed atmospheric pressure and a predetermined pressure value. The correction signal is adapted to be used by a pressure compensation element of the system for adjusting the system gain in a manner so as to compensate for the impact of deviations of the atmospheric pressure from a reference value (which typically is the atmospheric pressure prevailing at the time when the gas-filled chamber was sealed during manufacturing) on the compliance of a gas-filled chamber of the output transducer 12 (hence on the performance of the output transducer 12). In the example of FIG. 2 the correction signal from the correction signal unit 28 is supplied to the audio signal processing unit 40, in order to adjust the electrical gain applied to the audio signals in the audio signal processing unit 40, i.e. the pressure compensation element in this case is formed by or forms part of the audio signal processing unit 40. In practice, also the correction signal unit 28 may be implemented by the DSP forming the audio signal processing unit 40.

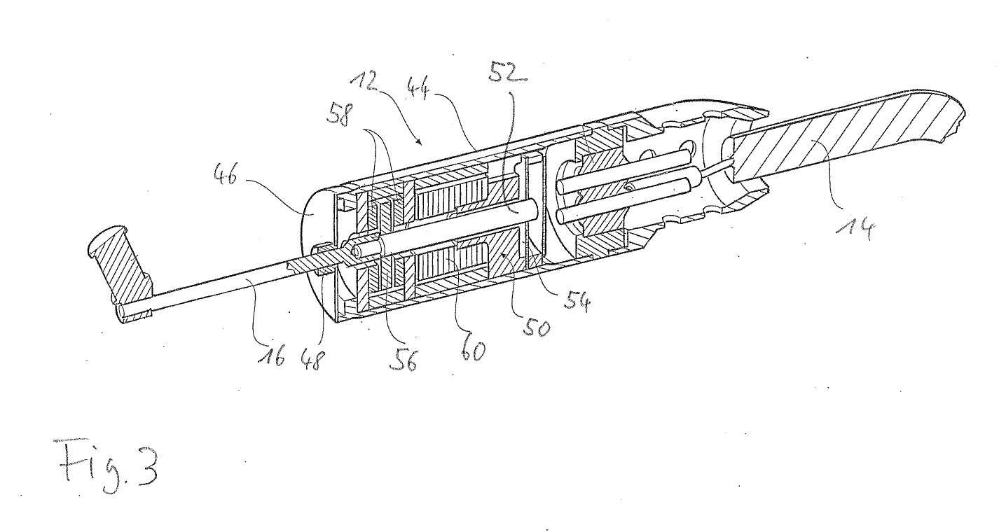

An example of the electromechanical output transducer 12 is shown in FIG. 3, wherein the transducer 12 comprises a hermetically sealed housing 44 which is closed on one end by a titanium diaphragm membrane 46 which has a titanium ring 48 in its center. The coupling rod 16 passes through the ring 48 which serves for fixing the coupling rod 16 at the membrane 46. The membrane 46 serves to hermetically seal the interior of the housing 44, which is typically filled with air, so that the housing 44 forms a hermetically sealed gas-filled chamber. The membrane 46 may be laser welded to the housing 44. The housing 44 surrounds an electromechanical actuator 50 which is a electromagnetic motor comprising a central shaft 52, one end of which is held in a spring bearing 54 and the other end of which is connected to the coupling rod 16, an armature 56, permanent magnets 58 and a signal coil 60 which receives a driving signal from the output driver 42. An output transducer of this type is described in detail in International Patent Application Publication WO 2006/058368 A1 and corresponding U.S. Patent Application Publication 2008/188707.

The electromechanical actuator 50 serves to impart a reciprocating movement to the central shaft 52, thereby vibrating the coupling rod 16. The membrane 46 serves to elastically support the coupling rod 16 at one end, thereby performing the function of a restoring spring. When the pressure gradient across the membrane 46, i.e. the difference between the gas contained in the hermetically sealed interior of the housing 44 and the pressure outside the housing 44, changes due to a change in barometric pressure, the deflection of the membrane 46 and hence its compliance will change, thereby affecting the compliance of the electromechanical actuator 50, whereby the performance of the output transducer 12 is affected.

According to a modification of the embodiment of FIG. 2, the correction signal unit 28, when generating the correction signal, will take into account not only the impact of the atmospheric pressure changes on the gas-filled chamber 44 of the output transducer 13, but also the effect of changes in atmospheric pressure on the performance of the microphone 20, if the microphone 20 comprises a hermetically sealed gas-filled chamber (the sum of the impact of atmospheric pressure changes on the microphone 20 and on the output transducer 12 determines the change in the overall system gain, which needs to be compensated for by the correction signal supplied to the audio signal processing unit 40).

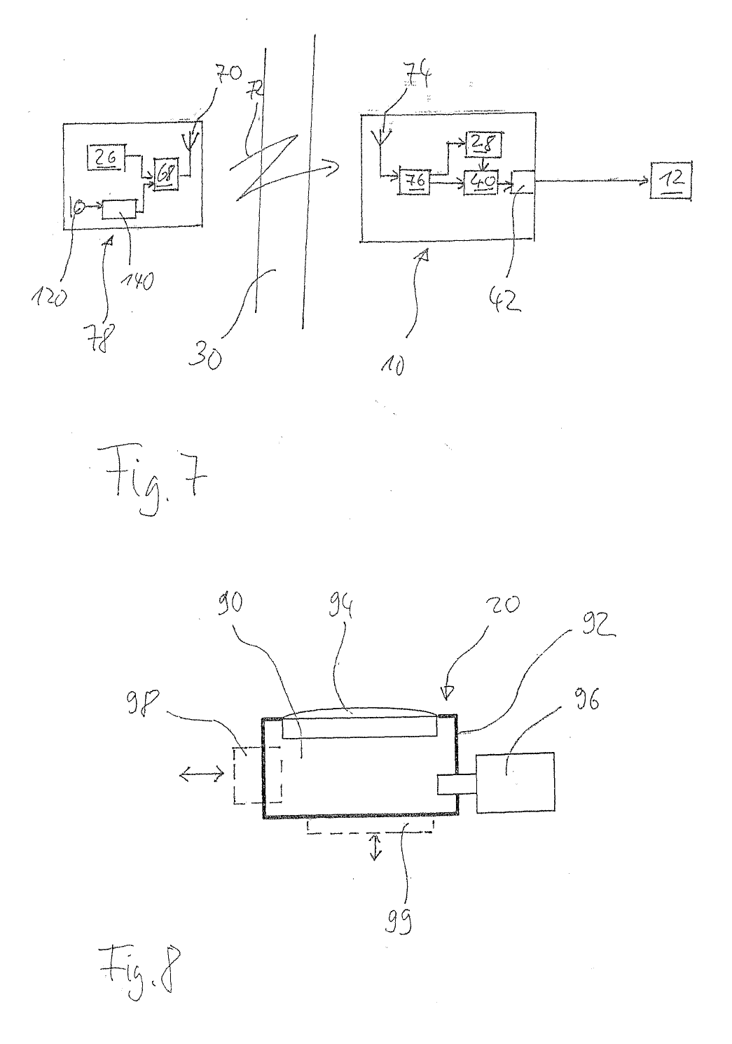

An example of a hermetically sealed microphone 20 is shown in FIG. 8, comprising a hermetically sealed chamber 90 within a housing 92 which is closed by a laser-welded membrane 94 and pressure sensor 96, typically a conventional miniature microphone, which converts the sound pressure in the chamber 90 into an electrical signal. The membrane 94 reacts to barometric pressure and to sound pressure. The performance of the microphone 20 depends on the static deflection of the membrane 94 and hence on the difference between the pressure within the chamber 90 and the atmospheric pressure around the housing 92.

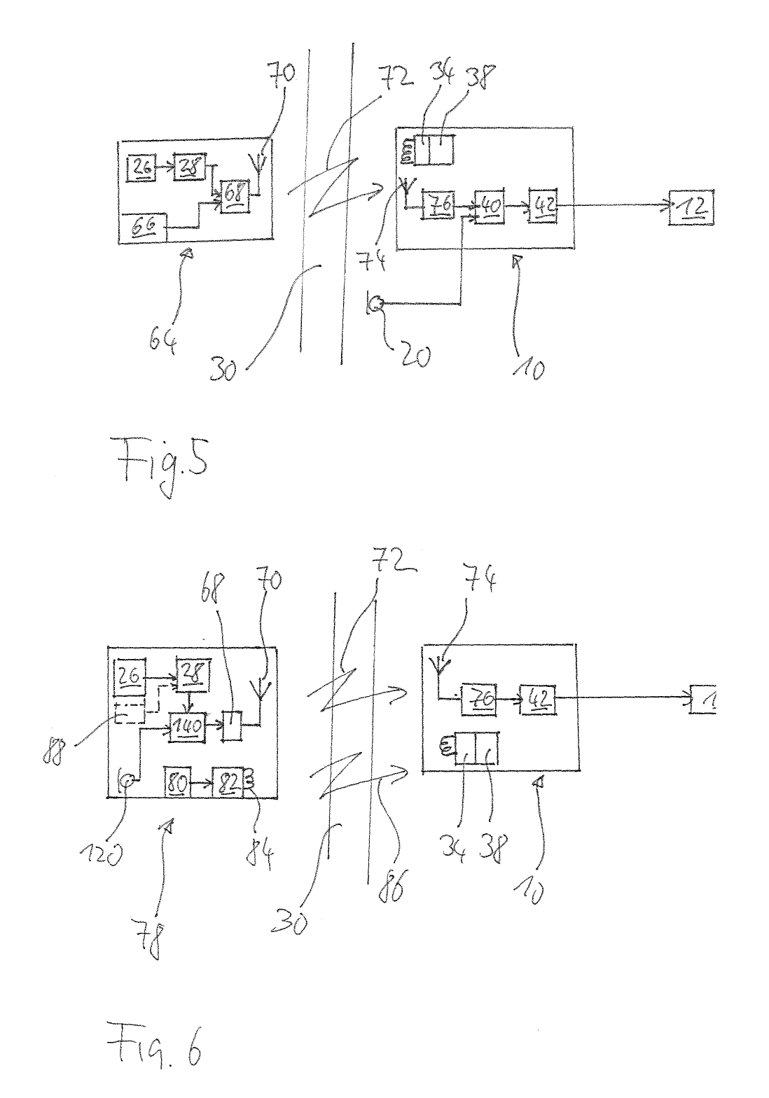

A modified embodiment of the system of FIG. 2 is shown in FIG. 4, wherein the correction signal from the correction signal unit 28 is not supplied to the audio signal processing unit 40, but rather to a mechanical pressure compensation element 62, which is coupled to or forms part of the output transducer 12 and which is adapted to mechanically displace an appropriate component of the output transducer 12 according to the correction signal in order to compensate for the compliance change caused by atmospheric pressure changes. For example, the mechanical pressure compensation element 62 may be realized by a piston-like element that moves into and out of the gas-filled hermetically sealed chamber in order to reduce or increase the volume of the chamber, thereby adjusting the pressure in order to compensate for the changes in atmospheric pressure. The piston-like element may be moved by an actuator such as a piezo-element.

According to an alternative example, the mechanical pressure compensation element 62 may be realized by a pressure compensation (i.e. second) membrane that is part of the gas-filled, hermetically sealed chamber, and which is moved by an actuator such as a piezo-element.

Such mechanical pressure compensation element 62 may be similarly applied to a hermetically sealed microphone, like the one shown in FIG. 8, where a piston-like pressure compensation element is indicated at 98 and a pressure compensation membrane is indicated at 99 (the actuator required for moving the pressure compensation elements 98, 99 is not shown in FIG. 8).

This mechanical pressure compensation element 62 may be operated in open loop condition, like the electrical solution described above, i.e. the output of the barometric pressure sensor is transformed using a known function of pressure to gain or pressure to desired mechanical position, and then applied to the driver of the mechanical pressure compensation element. The mechanical pressure compensation element 62 may also be operated in closed loop condition, wherein the driving signal for the actuator of the mechanical pressure compensation element is a function of the difference between the current static deflection or strain of the “working membrane” (which is formed by the membrane 46 in the example of FIG. 3 and by the membrane 94 in the example of FIG. 8), and a desired static deflection or strain. This version has the advantage of not needing a predetermined function of the correction signal versus barometric pressure.

Another modification of the embodiment of FIG. 2 is shown in FIG. 5, wherein the system includes a remote control 64, which includes a user control panel 66, a transmitter 68 and an antenna 70 for transmitting control commands via a wireless subcutaneous data link 72 to the implanted hearing aid, which in this case in addition comprises an antenna 74 and a receiver 76 for receiving the control signals and for supplying the respective control commands to the audio signal processing unit 40. Such control commands may be “system on/off”, “volume up”, “volume down”, etc. In the embodiment shown in FIG. 5 the barometric pressure sensor 26 is included in the remote control 64 rather than being implanted. Accordingly, also the correction signal unit 28 may be included in the remote control 64, so that the correction signal generated by the correction signal unit 28 according to the output of the atmospheric pressure sensor 26 can be supplied to the transmitter 68, in order to transmit the correction signal via the data link 72 to the receiver 76 and from there to the audio signal processing unit 40.

In FIG. 6, an example of a partially implantable hearing aid is shown, wherein an external unit 78 is provided which is worn outside the user's body at the user's head. The external unit 78 may be fixed at the patient's skin 30 in a position opposite to the implantable housing 10, for example, by magnetic forces created by cooperating fixation magnets provided in the external unit 78 and the implantable housing 10, respectively (these magnets are not shown in FIG. 6). The external unit 78 comprises a microphone arrangement 120 (usually formed by at least two spaced-apart microphones, which are not shown in FIG. 6) for capturing audio signals from ambient sound, which audio signals are supplied to an audio signal processing unit 140, wherein they may undergo, for example, acoustic beamforming. The audio signals processed by the audio signal processing unit 140 are supplied to the transmitter 68 connected to the transmission antenna 70 in order to transmit the processed audio signals via an inductive transcutaneous link 72 to the implantable unit 10, which comprises a receiver antenna 74 connected to a receiver 76 for receiving the transmitted audio signals which are then supplied to the driver unit 42 driving the output transducer 12.

The external unit 78 also includes a barometric pressure sensor 26 and a correction signal unit 28, which generates a correction signal as a function of the pressure sensed by the sensor 26, which correction signal is supplied to the audio signal processing unit 140 for adjusting the gain applied to the audio signals captured by the microphone arrangement 120, in order to compensate for the impact of atmospheric pressure changes on the performance of the output transducer 12.

The external unit 78 also comprises a power supply 80, which may be a replaceable or rechargeable battery, a power transmission unit 82 and a power transmission antenna 84 for transmitting power to the implantable housing 10 via wireless power link 86.

According to a modified version of the system shown in FIG. 6, the microphone arrangement 120 may by hermetically sealed and, to this end, may comprise a microphone of the type shown in FIG. 7. Such hermetically sealed microphones outside the patient's body may be needed to enable the external unit 78 to resist certain environmental conditions, e.g., to make the external unit 78 waterproof

In general, the deflection/compliance of the membrane of the hermetically sealed gas-filled chamber not only depends on the prevailing atmospheric pressure outside the chamber, but also on the temperature of the gas in the chamber (for example, if the temperature increases, the membrane deflection will increase even if the atmospheric pressure remains constant). In cases in which the hermetically sealed gas-filled chamber is implanted this effect usually is not a problem since the body temperature is essentially constant. However, it may be problem in cases in which the hermetically sealed gas-filled chamber is located outside the body, like in the case of a microphone in a waterproof environment. In order to take this effect into account, in variant of the embodiment of FIG. 6 comprising a hermetically sealed microphone 120, a temperature sensor 88 may be provided close to the gas-filled chamber of the hermetically sealed microphone 120, in order to generate a temperature signal which is supplied to the correction signal unit 28 in order to be taken into account when the correction signal is generated.

FIG. 7 shows a modification of the example shown in FIG. 6, wherein the implantable unit 10 is provided with an audio signal processing unit 40 and with the correction signal unit 28, while the external unit 78 does not include a correction unit. Rather than supplying the output signal of the pressure sensor 26 directly to the correction signal unit 28 (as in the example of FIG. 6), in the example of FIG. 7 the output signal of the pressure sensor 26 is supplied to the transmitter 68 for transmitting a corresponding data signal via the transcutaneous link 72 to the receiver 76 of the implantable unit 10. The audio signals received by the receiver 76 from the external unit 78 are supplied to the audio signal processing unit 40, while the received pressure signal is supplied to the correction signal unit 28 which supplies a corresponding correction signal to the audio signal processing unit 40, in order to adjust the system gain according to the sensed atmospheric pressure. In case that the system includes an implanted temperature sensor 88 close to the output transducer 12, the temperature signal provided by the temperature sensor 88 is supplied to the correction signal unit 28 for being taken into account when generating the correction signal, as described above in connection with FIG. 2.

In all embodiments, the correction signal unit 28 uses a certain algorithm describing the effect of static pressure (and optionally temperature) on the system gain in order calculate the appropriate correction signal as a function of the sensed barometric pressure (and optionally the sensed temperature). According to one embodiment, such algorithm may produce a scalar value, which is applied to correct the gain at all frequencies. In an alternative embodiment, the algorithm may produce a vector of numbers, which describes the required gain correction for a plurality of frequency bands, so that also the frequency dependency of the effect of static pressure (and optionally temperature) on the system gain can be taken into account; i.e. in this case the correction signal contains a separate correction value for each frequency band.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1-19. (canceled)

20. An at least partially implantable hearing assistance system, comprising an audio signal source, an audio signal processing unit for processing audio signals from the audio signal source, an implantable output transducer for stimulating a user's hearing according to the processed audio signals, a hermetically sealed gas-filled chamber forming part of said output transducer or forming part of an microphone as said audio signal source, a barometric pressure sensor for sensing a presently prevailing atmospheric pressure, and a correction signal unit for generating a correction signal as a predetermined function of a sensed atmospheric pressure, wherein said correction signal is adapted to be used by a pressure compensation element of the system for adjusting a system gain in a manner so as to compensate for an impact of deviations of the atmospheric pressure from a reference value on a compliance of said gas-filled chamber.

21. The system of claim 20, wherein the gas-filled chamber is sealed by a membrane forming part of the microphone or the implantable output transducer, with a compliance of the membrane depending on the atmospheric pressure.

22. The system of claim 21, wherein the membrane has been laser-welded to a housing of the microphone or the implantable output transducer.

23. The system of claim 20, wherein the microphone is implantable.

24. The system of claim 20, wherein the gas-filled chamber contains one of air, an inert gas and a mixture of inert gases.

25. The system of claim 20, wherein the pressure compensation element is adapted to adjust an electrical gain applied to the audio signals prior being supplied to the output transducer.

26. The system of claim 25, wherein the pressure compensation element forms part of the audio signal processing unit.

27. The system of claim 20, wherein the pressure compensation element comprises an implantable component which is adapted to be mechanically displaced according the correction signal in order to compensate for a compliance change caused by the deviations of the atmospheric pressure from the reference value.

28. The system of claim 27, wherein said implantable component is a membrane or a piston forming part of the hermetically sealed chamber.

29. The system of claim 20, wherein the barometric pressure sensor forms part of a non-implantable component of the hearing assistance system.

30. The system of claim 29, wherein the barometric pressure sensor forms part of a remote control enabling user control of the hearing assistance system.

31. The system of claim 29, wherein the barometric pressure sensor forms part of an external unit comprising a microphone as said audio signal source, said audio signal processing and means for establishing a wireless subcutaneous data link in order to supply processed audio signals to the implantable output transducer.

32. The system of claim 29, wherein the correction signal unit forms part of said non-implantable component.

33. The system of claim 32, wherein said non-implantable component comprises means for establishing a wireless subcutaneous data link in order to supply the correction signal to the pressure compensation element.

34. The system of claim 20, wherein the barometric pressure sensor is adapted for being implanted at a location close to the gas-filled chamber.

35. The system of claim 20, further comprising an implantable temperature sensor located close to the gas-filled chamber, wherein the correction signal unit is adapted to generate the correction signal as a predetermined function of both the sensed atmospheric pressure and a temperature sensed by the implantable temperature sensor so as to also compensate for deviations of a temperature at the location of the gas-filled chamber from a reference value.

36. The system of claim 20, wherein the correction signal unit is adapted to generate the correction signal as being the same for all audio frequencies.

37. The system of claim 20, wherein the correction signal unit is adapted to generate the correction signal separately for different frequency bands.

38. A method of providing hearing assistance to a user by an at least partially implantable hearing aid comprising an audio signal source, an audio signal processing unit and a hermetically sealed gas-filled chamber forming part of an output transducer for stimulating a hearing of the user or forming part of a microphone as said audio signal source, the method comprising the steps of:
supplying audio signals from the audio signal source,
processing said audio signals by the audio signal processing unit,
stimulating the user's hearing according to the processed audio signals by the implanted output transducer,
sensing a presently prevailing atmospheric pressure by a barometric pressure sensor,
generating a correction signal as a predetermined function of the sensed atmospheric pressure; and
using the correction signal for adjusting a system gain in a manner so as to compensate for an impact of deviations of the atmospheric pressure from a reference value on a compliance of said gas-filled chamber.
